(19) United States
(12) Patent Application Publication
(10) Pub. No.: US 2022/0389622 A1
(43) Pub. Date: Dec. 8, 2022

(54) STAPLE FIBER FOR AIRLAYING, AND METHOD FOR PRODUCING SAME

(71) Applicant: UBE EXSYMO CO., LTD., Tokyo (JP)

(72) Inventor: Isamu KOGURE, Tokyo (JP)

(21) Appl. No.: 17/767,259

(22) PCT Filed: Sep. 29, 2020
(86) PCT No.: PCT/JP2020/036876

§ 371 Date: Apr. 7, 2022

(30) Foreign Application Priority Data
Oct. 9, 2019 (JP) 2019-186417

(51) Int. Cl. D01F 8/06; D06M 15/643; D01D 5/34; D04H 1/728; D01D 10/00; D01F 11/06; D06M 13/292; D04H 1/4382; D04H 1/4291

(52) U.S. Cl. CPC D01F 8/06; D06M 15/643; D01D 5/34; D04H 1/728; D01D 10/00; D01F 11/06; D06M 13/292; D04H 1/43828; D04H 1/4291; D06M 2101/20

(57) ABSTRACT

Provided are staple fibers for air laid capable of improving dispersibility, and a method for producing the same. The staple fibers for air laid are characterized by including stable fibers to which a fiber treatment agent containing a hydrophilic oil agent and a silicone-containing oil agent is adhered in an amount of 0.7 to 2 wt % of a weight of the staple fibers, wherein a weight ratio of the hydrophilic oil agent and the silicone-containing oil agent contained in the fiber treatment agent (a weight of the hydrophilic oil agent/a weight of the silicone-containing oil agent) is within a range of 60/40 to 90/10, and a moisture content is 2 to 13%.

### TECHNICAL FIELD

The present invention relates to staple fibers for air laid, and a method for producing the same.

### BACKGROUND ART

Composite fibers having a sheath core structure formed using two types of resins with different characteristics are used in a wide range of fields. For example, olefinic composite fibers are applied to a non-woven fabric. The non-woven fabric is, for example, configured such that chemical fibers such as olefinic fibers are oriented in one direction or randomly, and the fibers are bonded by fusion, adhesion, or the like and processed into a sheet form. The non-woven fabric using the olefinic composite fibers has excellent chemical resistance, and is also used in various filter materials, battery separators, and the like.

The composite fibers having a sheath core structure are generally produced by forming undrawn fibers having a sheath core structure by melt spinning and subjecting the undrawn fibers to a drawing treatment. As a method for producing a non-woven fabric, a method in which fibers after a drawing treatment obtained as described above are cut to a predetermined length to form staple fibers (staples), and a non-woven fabric is produced using a dry process by performing an opening treatment, or a method in which a non-woven fabric is produced using a wet process by dispersing the staple fibers in water are known.

PTL 1 discloses staple fibers for an air laid non-woven fabric in which a fiber treatment agent containing an alkyl phosphate ester salt and a silicone-based compound is adhered to staple fibers. It is described that with respect to air openability (dispersibility), the dispersibility becomes favorable by combining a monoalkyl phosphate ester salt content and a polyphosphate ester salt content in the alkyl phosphate ester salt, and a lubrication agent which is a silicone-based compound having an appropriate molecular weight.

PTL 2 discloses a method for producing drawn composite fibers by subjecting undrawn fibers having a sheath core structure to a drawing treatment, and drawn composite fibers produced by the method.

### CITATION LIST

### Patent Literature

PTL 1: Japanese Patent No. 5038848

PTL 2: Japanese Patent No. 5938149

### SUMMARY OF INVENTION

### Technical Problem

However, staple fibers of ultrafine fibers having a fineness of 1 dTex or less have a larger surface area and a higher fiber density per unit volume as compared with fibers having a larger fineness, so that static electricity is likely to be charged, and aggregation is likely to occur. Further, the number of fibers per unit volume increases, and the fibers tend to be strongly entangled with each other. Therefore, the dispersibility (air openability) tends to deteriorate. When the moisture content is high, the fibers are less likely to come apart due to bundling by wetting, and the dispersibility tends to deteriorate. When the moisture content is low, a frictional resistance between the fiber and a blade at the time of cutting increases to decrease the sharpness, and the shape of the fiber in the cut cross section collapses and the dispersibility tends to deteriorate.

Therefore, an object of the present invention is to provide staple fibers for air laid capable of improving dispersibility, and a method for producing the same.

### Solution to Problem

Staple fibers for air laid according to the present invention include stable fibers to which a fiber treatment agent containing a hydrophilic oil agent and a silicone-containing oil agent is adhered in an amount of 0.7 to 2 wt % of a weight of the staple fibers, wherein a weight ratio of the hydrophilic oil agent and the silicone-containing oil agent contained in the fiber treatment agent (a weight of the hydrophilic oil agent/a weight of the silicone-containing oil agent) is within a range of 60/40 to 90/10, and a moisture content is 2 to 13%.

A method for producing staple fibers for air laid according to the present invention includes obtaining undrawn fibers by melt spinning, adhering a fiber treatment agent containing a hydrophilic oil agent and a silicone-containing oil agent to the undrawn fibers in an amount of 0.7 to 2 wt % of a weight of the fibers, forming drawn fibers by subjecting the undrawn fibers to a drawing treatment, and cutting the drawn fibers to a predetermined length, wherein a weight ratio of the hydrophilic oil agent and the silicone-containing oil agent contained in the fiber treatment agent (a weight of the hydrophilic oil agent/a weight of the silicone-containing oil agent) is within a range of 60/40 to 90/10, and the drawn fibers after the cutting the drawn fibers have a moisture content of 2 to 13%.

### Advantageous Effects of Invention

In the staple fibers for air laid of the present invention, the adhesion amount of the fiber treatment agent, the weight ratio of the hydrophilic oil agent and the silicone-containing oil agent contained in the fiber treatment agent (the weight of the hydrophilic oil agent/the weight of the silicone-containing oil agent), and the moisture content are regulated, and therefore, bundling of the fibers due to wetting or an increase in the frictional resistance between the fiber and a blade at the time of cutting is suppressed, so that the dispersibility can be improved.

In the method for producing staple fibers for air laid of the present invention, the production is performed by regulating the adhesion amount of the fiber treatment agent, the weight ratio of the hydrophilic oil agent and the silicone-containing oil agent contained in the fiber treatment agent (the weight of the hydrophilic oil agent/the weight of the silicone-containing oil agent), and the moisture content, and therefore, staple fibers for air laid with dispersibility improved by suppressing bundling of the fibers due to wetting or an increase in the frictional resistance between the fiber and a blade at the time of cutting can be produced.

### BRIEF DESCRIPTION OF DRAWINGS

FIG. 1 is a schematic view illustrating a production apparatus for producing staple fibers for air laid of an embodiment.

FIG. 2 is a schematic view illustrating a configuration of a test device (primary opening evaluation) involved in Examples.

FIG. 3 is a schematic view illustrating a configuration of a test device (permeability evaluation) involved in Examples.

FIG. 4 is an SEM image showing cross sections of staple fibers after a cutting treatment of Example 1.

FIG. 5 is an SEM image showing cross sections of staple fibers after a cutting treatment of Comparative Example 2.

### DESCRIPTION OF EMBODIMENTS

Hereinafter, embodiments of the present invention will be described in detail with reference to the drawings.

### 1. Configuration of Staple Fibers for Air Laid

The staple fibers for air laid according to the present embodiment include staple fibers to which a fiber treatment agent containing a hydrophilic oil agent and a silicone-containing oil agent is adhered in an amount of 0.7 to 2 wt % of a weight of the staple fibers. A weight ratio of the hydrophilic oil agent and the silicone-containing oil agent contained in the fiber treatment agent (a weight of the hydrophilic oil agent/a weight of the silicone-containing oil agent) is within a range of 60/40 to 90/10. The staple fibers for air laid according to the present embodiment have a moisture content of 2 to 13%.

### (Fiber Treatment Agent)

The hydrophilic oil agent contained in the fiber treatment agent is, for example, an alkyl phosphate ester salt. The alkyl phosphate ester salt includes a monoalkyl phosphate ester salt, a dialkyl phosphate ester salt, a polyphosphate ester salt, or a mixture thereof. The average number of carbon atoms in the alkyl group contained in the alkyl phosphate ester salt is, for example, 6 to 22.

The silicone-containing oil agent contained in the fiber treatment agent contains, for example, a siloxane compound obtained by substituting some or all of the methyl groups in polydimethylsiloxane or polymethylsiloxane with a substituent such as an alkyl group having 2 or more carbon atoms, a phenyl group, a phenylalkyl group, an amino group, or the like, a siloxane compound obtained by graft polymerization of a polyoxyalkylene or the like, or a mixture thereof.

### (Weight Ratio of Oil Agents in Fiber Treatment Agent)

The fiber treatment agent contains a hydrophilic oil agent and a silicone-containing oil agent. The blending amount of the hydrophilic oil agent to be blended in the fiber treatment agent is 60 to 90 wt % based on the total weight of the fiber treatment agent. If the amount exceeds 90 wt %, the blending amount of the silicone-containing oil used in combination decreases, and therefore, a frictional resistance between the fiber and a blade when cutting into staple fibers increases to decrease the sharpness, and the shape of the cut cross section collapses to lower the dispersibility, and therefore, such an amount is not preferable. If the amount is less than 60 wt %, static electricity is likely to occur due to the small amount of the hydrophilic oil agent component, and the fibers are charged and gather into a lump to lower the dispersibility, and therefore, such an amount is not preferable.

A remainder excluding the hydrophilic oil agent in the fiber treatment agent is, for example, the silicone-containing oil agent excluding unavoidable components. The blending amount of the silicone-containing oil agent is 10 to 40 wt % based on the total weight of the fiber treatment agent. The weight ratio of the hydrophilic oil agent and the silicone-containing oil agent contained in the fiber treatment agent (the weight of the hydrophilic oil agent/the weight of the silicone-containing oil agent) is within a range of 60/40 to 90/10. If the weight ratio of the hydrophilic oil agent and the silicone-containing oil agent contained in the fiber treatment agent exceeds 90/10, a frictional resistance between the fiber and a blade when cutting into staple fibers increases to decrease the sharpness, and the shape of the cut cross section collapses to lower the dispersibility, and therefore, such a weight ratio is not preferable. If the weight ratio is less than 60/40, static electricity is likely to occur, and the fibers are charged and gather into a lump to lower the dispersibility, and therefore, such a weight ratio is not preferable.

The fiber treatment agent may contain a component other than the hydrophilic oil agent and the silicone-containing oil agent as long as the target antistatic property and cutability are not impaired. Even in this case, the ratio of the weight of the hydrophilic oil agent to the weight of the silicone-containing oil agent is within the range of 60/40 to 90/10.

### (Adhesion Amount of Fiber Treatment Agent)

The adhesion amount of the fiber treatment agent to the staple fibers is 0.7 to 2 wt % with respect to the total weight of the staple fibers. If the adhesion amount is less than 0.7%, static electricity is likely to occur, and the fibers are charged and gather into a lump to lower the dispersibility, and therefore, such an amount is not preferable. If the adhesion amount is larger than 2 wt %, due to the bundling property of the fiber treatment agent itself, an unopened bundle is likely to be formed, and therefore, such an amount is not preferable.

### (Moisture Content of Staple Fibers)

The moisture content of the staple fibers is 2 to 13 wt % with respect to the total weight of the staple fibers. Here, the moisture content of the staple fibers is an initial moisture content after the below-mentioned step of cutting into staple fibers. If the moisture content is less than 2%, a frictional resistance between the fiber and a blade when cutting into staple fibers increases to decrease the sharpness, and the shape of the cut cross section collapses to lower the dispersibility, and therefore, such a moisture content is not preferable. If the moisture content exceeds 13 wt %, the fibers are heavily wet and an unopened bundle is likely to be formed due to the bundling property of the fibers, and therefore, such a moisture content is not preferable. Amore preferable range of the moisture content of the staple fibers is 5 to 10 wt %, so that the dispersibility can be enhanced.

### (Fineness)

The fineness of the staple fibers is preferably 0.01 to 1.0 dTex. If the fineness is less than 0.01 dTex, deterioration of yarn quality such as yarn breakage or fluffing is significant in the spinning step, and not only does it become difficult to stably produce fibers of good quality, but also the production amount per hour decreases, and therefore, the production cost increases, and such a fineness is not preferable. If the fineness exceeds 1.0 dTex, it becomes difficult to obtain high strength and denseness of a non-woven fabric in a low basis weight region where the characteristics of ultrafine fibers can be exhibited, and therefore, such a fineness is not preferable. A more preferable range of the fineness of the staple fibers is 0.1 to 0.8 dTex, so that the quality of the fibers can be improved, the production cost can be reduced, and the strength and denseness of a non-woven fabric can be increased.

### (Staple Fibers)

The staple fibers are preferably composite fibers having a sheath core structure in which a resin containing a crystalline propylene-based polymer as a main component is used as a core material, and a resin containing an olefinic polymer having a melting point lower than that of the core material as a main component is used as a sheath material. It is possible to obtain a uniform non-woven fabric from staple fibers of olefinic composite fibers, and since chemical resistance is excellent, a non-woven fabric to be used for various filter materials and battery separators can be obtained.

Examples of the crystalline propylene-based polymer, which is the main component of the core material, include an isotactic propylene homopolymer having crystallinity, an ethylene-propylene random copolymer having a low ethylene unit content, a propylene block copolymer constituted by a homo portion composed of a propylene homopolymer and a copolymerization portion composed of an ethylene-propylene random copolymer having a relatively high ethylene unit content, and further, a crystalline propylene-ethylene-α-olefin copolymer composed of a substance obtained by further copolymerization of each homo portion or copolymerization portion in the above-mentioned propylene block copolymer with an α-olefin such as butene-1, and the like. Among these, isotactic polypropylene is preferable from the viewpoint of drawability, fiber physical properties, and suppression of thermal shrinkage.

Examples of the olefinic polymer, which is the main component of the sheath material, include an ethylene-based polymer such as high-density, medium-density, or low-density polyethylene and linear low-density polyethylene, a copolymer of propylene and another α-olefin, specifically, a propylene-butene-1 random copolymer, a propylene-ethylene-butene-1 random copolymer, or an amorphous propylene-based polymer such as soft polypropylene, poly(4-methylpentene-1), and the like. Among these olefinic polymers, one type may be used singly or two or more types may be used in combination. Above all, particularly, high-density polyethylene is preferable from the viewpoint of fiber physical properties. The various organic resins listed above may be olefinic compositions containing a known additive such as a pigment, a dye, a matting agent, an antifouling agent, an antibacterial agent, a deodorant, a fluorescent brightening agent, an antioxidant, a flame retardant, a stabilizer, a UV absorber, or a lubricant.

### (Sheath Core Cross-Sectional Area Ratio)

A cross-sectional area ratio of the sheath material and the core material (sheath/core) is preferably within a range of 5/95 to 80/20. If the ratio is less than 5/95, the adhesion between the fibers when the fibers are formed into a non-woven fabric becomes weak due to the lack of the sheath component, and in a region exceeding 80/20, the strength of the fiber alone becomes weak due to the lack of the core component, and therefore, it becomes difficult to obtain an advantage brought about by the composite fiber.

### (Cut Length of Staple Fiber)

A fiber length of the staple fiber is preferably 1 to 10 mm. If the fiber length is too shorter than 1 mm, a non-woven fabric is often not strong, and if the fiber length is too longer than 10 mm, the fibers are easily entangled with each other, so that the fibers gather into a lump to deteriorate the dispersibility. A more preferable range of the fiber length of the staple fiber is 2 to 5 mm, so that the dispersibility can be enhanced and the strength of the non-woven fabric can be ensured.

### (Additive)

It is preferable that a nucleating agent is blended in the core material (a resin containing a crystalline propylene-based polymer as a main component). When the nucleating agent is added to the core material, the nucleating agent acts as a crystal nucleus by itself or acts on the crystalline propylene-based polymer as a nucleating agent that induces crystal formation while the molten core material is discharged from a spinneret and cooled, and therefore, a recrystallization temperature rises. As a result, cooling in the spinning step is stabilized, unevenness of the fineness of spun fibers (undrawn fibers), unevenness of the sheath-core ratio in the fibers, and unevenness of coating with the sheath material where the core material is not coated with the sheath material and is partially exposed can be reduced. As the nucleating agent to be added to the core material, an inorganic nucleating agent or an organic nucleating agent can be used. Specific examples of the inorganic nucleating agent include talc, kaolin, silica, carbon black, titanium oxide, zinc oxide, magnesium oxide, aluminum oxide, neodymium oxide, calcium sulfate, barium sulfate, and the like. Specific examples of the organic nucleating agent include metal benzoate-based nucleating agents such as sodium benzoate and calcium benzoate, metal oxalate-based nucleating agents such as calcium oxalate, metal stearate-based nucleating agents such as magnesium stearate and calcium stearate, metal benzoate-based nucleating agents such as aluminum benzoate, potassium benzoate, and lithium benzoate, phosphoric acid ester metal salt-based nucleating agents, and dibenzylidene sorbitol-based nucleating agents. The nucleating agent may be either one that melts together when the resin serving as the core material and containing a crystalline propylene-based polymer as a main component is in a molten state, or one that does not completely melt and is dispersed in the resin, and may also be one to serve as a nucleus by itself without melting. In the present embodiment, in a relationship with the resin containing a crystalline propylene-based polymer as a main component, it is preferable to use a nucleating agent that melts together and has an affinity for the resin, and a nucleating agent that does not completely melt, but is partially compatible with the resin.

When such a nucleating agent is used, while sufficiently exhibiting the effect of reducing the unevenness of the fineness (thickness) among the fibers and the unevenness of the core-sheath component ratio in the fibers in the cooling immediately after spinning, the drawability in the subsequent drawing step can be further improved by the internal structure due to microcrystal formation. Since an inorganic nucleating agent does not melt, it is necessary to finely adjust the addition amount of the nucleating agent for each of the spinning condition and the drawing condition, however, an organic nucleating agent can be adapted to wider spinning and drawing conditions in a relatively small addition amount. Therefore, as the nucleating agent, it is preferable to use an organic nucleating agent, and particularly, in the relationship with the resin containing a crystalline propylene-based polymer as the main component, it is more preferable to use an organic nucleating agent from the viewpoint that both melt and are easily compatible with each other.

As the organic nucleating agent that melts together with the resin and has an affinity for the resin, for example, a dibenzylidene sorbitol-based nucleating agent is exemplified. Specifically, dibenzylidene sorbitol (DBS), monomethyldibenzylidene sorbitol (for example, 1,3:2,4-bis(p-methylbenzylidene) sorbitol (p-MDBS)), dimethyldibenzidene sorbitol (for example, 1,3:2,4-bis(3,4-dimethylbenzidene) sorbitol (3,4-DMDBS)), or the like is preferably used.

### 2. Production Apparatus for Staple Fibers for Air Laid

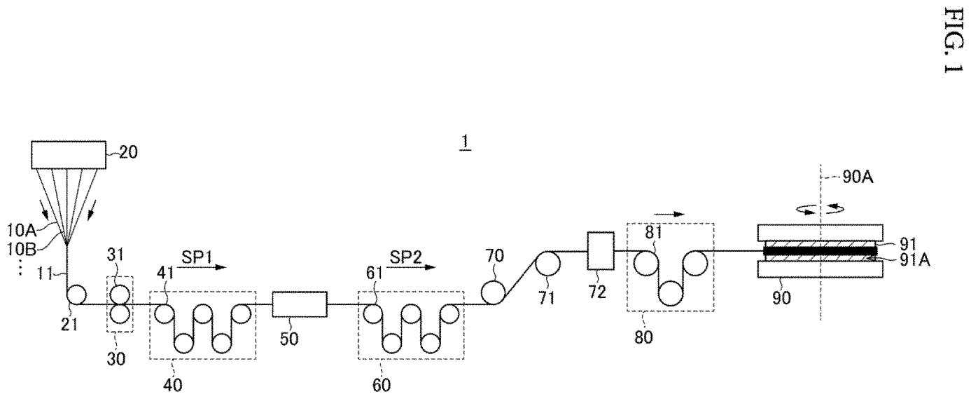

FIG. 1 is a schematic view illustrating a configuration of a production apparatus for producing staple fibers for air laid of the present embodiment.

As shown in FIG. 1, a production apparatus 1 includes a spinning section 20, a fiber treatment agent adhering section 30, a first roller 40, a drawing treatment section 50, a second roller 60, an adjusting section 72, an adjusting roller 80, and a cutter section 90.

The spinning section 20 is provided with a molten resin supply section (extruder cylinder) and a spinneret (nozzle). By melt spinning, for example, a plurality of undrawn fibers 10A, 10B, . . . , each of which has a sheath core structure in which a resin containing a crystalline propylene-based polymer as a main component is used as a core material, and a resin containing an olefinic polymer having a melting point lower than that of the core material as a main component is used as a sheath material are discharged. The obtained undrawn fibers 10A, 10B, . . . are conveyed as a tow 11 in which a plurality of fibers are collected and bundled.

The fiber treatment agent adhering section 30 adheres the fiber treatment agent to the conveyed tow 11 by an adhering roller 31. In FIG. 1, the configuration in which a conveying roller 21 is provided between the spinning section 20 and the fiber treatment agent adhering section 30 is shown, but the conveying roller 21 may be provided also at another place as appropriate. As the fiber treatment agent, a fiber treatment agent containing a hydrophilic oil agent and a silicone-containing oil agent at the above-mentioned weight ratio is used.

The first roller 40 conveys the tow 11 at a first conveying speed SP1. The first roller 40 includes a plurality of rollers 41.

The drawing treatment section 50 performs a drawing treatment of the tow 11 in which undrawn fibers are bundled. The drawing treatment is desirably performed at a high temperature, and by this, drawing at a high magnification can be achieved, and drawn composite fibers with a low fineness are obtained. As a heat drawing treatment, contact heating drawing with a high temperature heating plate, radiant heating drawing with far infrared light or the like, hot water heating drawing, steam heating drawing, pressurized saturated steam heating drawing, or the like can be applied. Steam heating drawing is preferable because the inside of the tow 11 can be heated uniformly in a short time.

When steam heating drawing is performed, the conditions are not particularly limited, but for example, heating is performed in a steam atmosphere at 100° C. under normal pressure. When drawing is performed in pressurized saturated steam, the conditions are not particularly limited, but it is usually performed at 100° C. or higher. The temperature of the pressurized saturated steam is basically preferably higher as long as the olefinic polymer of the sheath material does not melt. When considering the drawing magnification, drawing speed, economic efficiency, etc., a preferable temperature range of the pressurized saturated steam is 105 to 130° C., and more preferably 110 to 125° C.

The second roller 60 conveys the tow 11 subjected to the drawing treatment at a second conveying speed SP2. The second roller 60 includes a plurality of rollers 61. The drawing ratio by the drawing treatment section 50 can be adjusted by the ratio of the first conveying speed SP1 and the second conveying speed SP2. For example, when the second conveying speed SP2/the first conveying speed SP1 is X times, the fineness can be reduced to 1/X by the drawing treatment.

The drawing magnification can be appropriately selected according to the fineness of the undrawn fibers, but usually, the total drawing magnification is 3.0 to 10.0 times, and preferably 4.0 to 8.0 times. The drawing speed can be set to, for example, about 400 to 2000 m/min. In particular, when the spinning step and the drawing step are continuously performed, it is preferably set to 1000 m/min or more from the viewpoint of productivity.

The adjusting section 72 is a treatment section that performs an adjusting treatment such as a drying treatment or a humidifying treatment for the tow 11. If the adjusting treatment is not performed, the installation of the adjusting section 72 can be omitted. In FIG. 1, a configuration in which two conveying rollers 70 and 71 are provided between the second roller 60 and the adjusting section 72 is shown, but the conveying roller need not be provided if possible, or it may be configured to have one or three or more conveying rollers. Such a conveying roller may be provided also at another place of the production apparatus in FIG. 1 as appropriate.

The adjusting roller 80 adjusts the speed at which the tow 11 is supplied to the cutter section 90 by each roller 81 constituting the adjusting roller 80.

The cutter section 90 has a flat cylindrical section 91, and is provided with a cutting blade 91A on a side surface of the cylindrical section 91 toward the outside. When the tow 11 is taken up in the cylindrical section 91 by driving the cutter section 90 around a rotation shaft 90A, the tow 11 is pressed against the cutting blade 91A by the pressure when it is taken up, and the tow 11 is cut into staple fibers.

Although FIG. 1 shows a production apparatus of an inline system in which the members from the spinning section 20 to the cutter section 90 are continuously provided, but it may be a production apparatus of an outline system composed of a group of apparatuses provided individually for each step. It may also be configured such that a take-up roller is placed at a given place in the production apparatus and the tow 11 is taken up once, and steps thereafter are performed by taking up the tow 11 from the take-up roller.

### 3. Method for Producing Staple Fibers for Air Laid

With reference to FIG. 1, a method for producing staple fibers for air laid of the present embodiment will be described.

First, in the spinning section 20 shown in FIG. 1, a plurality of undrawn fibers 10A, 10B, . . . are discharged by melt spinning. The obtained undrawn fibers 10A, 10B, . . . are conveyed as the tow 11 in which the plurality of fibers are collected and bundled.

Subsequently, the fiber treatment agent is adhered to the tow 11 in the fiber treatment agent adhering section 30 shown in FIG. 1. As the fiber treatment agent, a fiber treatment agent containing a hydrophilic oil agent and a silicone-containing oil agent at the above-mentioned weight ratio is used.

Subsequently, the tow 11 is subjected to a drawing treatment in the drawing treatment section 50 while adjusting the conveying speed by the first roller 40 and the second roller 60 shown in FIG. 1. At this time, the drawing ratio is adjusted by the ratio of the second conveying speed SP2 to the first conveying speed SP1.

Subsequently, in the adjusting section 72 shown in FIG. 1, an adjusting treatment such as a drying treatment or a humidifying treatment for the tow 11 is performed. The adjusting treatment is performed as needed. In the below-mentioned Examples, in order to adjust the moisture content, a drying treatment or a humidifying treatment is performed in the adjusting section 72.

Subsequently, after adjusting the speed with the adjusting roller 80 shown in FIG. 1, in the cutter section 90, the tow is cut into staple fibers. The cut staple fibers are subjected to an opening treatment. By the opening treatment, the staple fibers are opened into a cotton-like state. In this manner, staple fibers for air laid can be produced.

The obtained staple fibers for air laid are processed into a non-woven fabric by an air laid method after an elapse of (storage for) a predetermined period as needed or immediately after being opened into a cotton-like state.

### 4. Action and Effect

The staple fibers for air laid of the present embodiment described above are configured by adhering the fiber treatment agent, in which the weight ratio of the hydrophilic oil agent and the silicone-containing oil agent (the weight of the hydrophilic oil agent/the weight of the silicone-containing oil agent) is within a range of 60/40 to 90/10, to staple fibers in an amount of 0.7 to 2 wt % of the weight of the staple fibers. The staple fibers for air laid have a moisture content of 2 to 13%.

In ultrafine fibers having a fineness of 1 dTex or less, a fiber density per unit volume is high and the number of fibers per unit volume is large, so that dispersibility tends to deteriorate. In the staple fibers for air laid of the present embodiment, the moisture content is adjusted to 2 to 13%, and therefore, the frictional resistance between the fiber and a blade when cutting into staple fibers is prevented from increasing, and an unopened bundle is prevented from being easily formed due to wetting of fibers, so that the dispersibility can be improved.

Since the weight ratio of the hydrophilic oil agent and the silicone-containing oil agent in the fiber treatment agent is within the range of 60/40 to 90/10, the frictional resistance between the fiber and a blade when cutting into staple fibers is prevented from increasing, and the fibers are prevented from being charged and gathering into a lump, so that the dispersibility can be improved.

Since the adhesion amount of the fiber treatment agent to the staple fibers is 0.7 to 2 wt %, the fibers are prevented from being charged and gathering into a lump, and an unopened bundle is prevented from being easily formed due to the bundling property of the fiber treatment agent itself, so that the dispersibility can be improved.

As described above, according to the present embodiment, staple fibers for air laid that can improve dispersibility can be provided.

### 5. Modification

In the above-mentioned embodiment, the fiber treatment agent is applied between the melt spinning step and the drawing treatment step, but the present invention is not limited thereto, and the agent may be applied at any timing from the melt spinning step to the cutting step. The staple fibers of the present embodiment are preferably applicable to a method for producing a non-woven fabric by an air laid method, but is also applicable to a method for producing a non-woven fabric by a dry process without using an air laid method.

### 6. Evaluation Method

### (1) Fineness

The fiber fineness of undrawn fibers and drawn fibers was measured according to JIS L 1013.

### (2) Oil Agent Adhesion Ratio

The oil agent adhering to fibers to be tested (weight: 2 g) was extracted with 20 cc of ethanol/methanol (mixing ratio: 2/1), and the ethanol/methanol remaining in the fibers was dried by heat, and then, the weight of the fibers obtained as a residue was measured. From the obtained weight of the residue, a weight loss amount (a weight of a component extracted with ethanol/methanol) was determined, and a value obtained by dividing the weight loss amount by the weight of the fibers to be tested was used.

(3) Initial Moisture Content after Cutting

For fibers to be tested (weight: 3 g), moisture adhering to the fibers was heated and dried by a built-in heater of a moisture content measuring device, and a value obtained by measuring a moisture content (wet base) by a built-in electronic balance was used.

### (4) Dry Dispersion Test

### (4-1) Primary Opening Evaluation

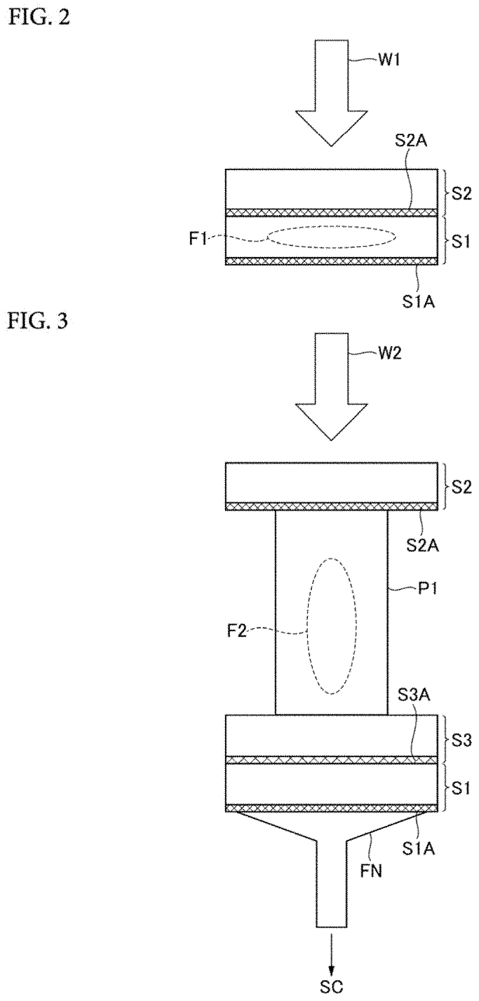

FIG. 2 is a schematic view illustrating a configuration of a test device used in a test for primary opening evaluation. It has a configuration in which a sieve S1 having an opening S1A with an aperture of 250 μm and a sieve S2 having an opening S2A with an aperture of 250 μm are stacked. Fibers to be tested F1 (weight: 1 g) after cutting and before opening were put between the stacked sieve S1 and sieve S2, and it was evaluated whether the fibers to be tested F1 were opened into a cotton-like state when air W1 at a pressure of 0.4 MPa was evenly applied to the fibers to be tested F1 for 30 seconds from an upper part of the sieve S2. In Table 1, a case where the fibers are opened is indicated by “◯”, and a case where the fibers are not opened is indicated by “X”.

### (4-2) Passability Evaluation

FIG. 3 is a schematic view illustrating a configuration of a test device used in a test for passability evaluation and the below-mentioned texture evaluation. A suction portion SC is provided at a tip of a tubular portion of a plastic funnel FN having a conical portion and the tubular portion extending from a tip thereof. It has a configuration in which on the funnel FN, a sieve S1 having an opening S1A with an aperture of 250 μm, a sieve S3 having an opening S3A with an aperture of 2.36 mm, a tubular portion P1, and a sieve S2 having an opening S2A with an aperture of 250 μm are stacked. Staple fibers F2 (weight: 1 g) opened into a cotton-like state in the above-mentioned primary opening evaluation were put into the tubular portion P1, an upper part of the tubular portion P1 was covered with the sieve S2 as if covered with a lid, and air W2 at 0.4 MPa was evenly applied to the staple fibers F2 for 1 minute from an upper part of the sieve S2 while sucking from a tip portion of the funnel FN with a vacuum cleaner having a suction power of 160 W by the suction portion SC. As a measurement value related to the passability evaluation, a weight of residual staple fibers (the staple fibers that did not pass through the sieve S3) in the tubular portion P1 was measured after the air W2 was applied, and a value obtained by dividing the weight by the weight (1 g) of the put staple fibers F2 was used. A numerical value of the passability evaluation is preferably 60% or less, and more preferably 40% or less.

### (4-3) Texture Evaluation

In the test device shown in FIG. 3 described above, the staple fibers F2 (weight: 1 g) opened into a cotton-like state in the above-mentioned primary opening evaluation were put into the tubular portion P1, an upper part of the tubular portion P1 was covered with the sieve S2 as if covered with a lid, and air W2 at 0.4 MPa was evenly applied to the staple fibers F2 for 1 minute from an upper part of the sieve S2 while sucking from a tip portion of the funnel FN with a vacuum cleaner having a suction power of 160 W by the suction portion SC. In the texture evaluation, appearance of web-like staple fibers (size f: 200 mm) in the sieve S1 after applying the air W2 were visually observed and evaluated according to the following criteria.

Evaluation A indicates that “a fiber lump with a length of 3 mm or more or an uneven basis weight spot (shade) is not observed, and the texture is uniform”. Evaluation B indicates that “there are less than 10 fiber lumps with a length of 3 mm or more, and an uneven basis weight spot (shade) can be confirmed by visual observation”. Evaluation C indicates that “10 or more fiber lumps with a length of 3 mm or more are observed, and an uneven basis weight spot (shade) is remarkable, and the texture is not uniform”. When the staple fibers do not pass through the sieve S3 in the passability evaluation, the texture evaluation cannot be performed, and therefore, such a case is not evaluable and is indicated by a symbol “-”. In the texture evaluation, Evaluation A is preferable.

### (5) Wet Dispersion Test

### (5-1) Primary Dispersion Evaluation

In a 100 L water tank, fibers to be tested (weight: 2 g) after cutting and before opening were placed and stirred at a stirring rate of 2800 rpm for 10 minutes, and then, the number of fiber lumps with a length of 3 mm or more was measured. As a numerical value of the primary dispersion evaluation, the number of fiber lumps is preferably 40 or less.

### (5-2) Secondary Dispersion Evaluation

In a 500 mL beaker, 300 mL of water was placed, and the fiber lumps with a length of 3 mm or more obtained in the above-mentioned primary dispersion test were placed in water and stirred at a stirring rate of 5000 rpm for 5 minutes using a pencil mixer, and then, the number of fiber lumps with a length of 3 mm or more was measured. As a numerical value of the secondary dispersion evaluation, the number of fiber lumps is preferably 0.

### (6) Cut Cross Section

Cut surfaces of fibers to be tested after cutting and before opening were observed with SEM. Deformation of the shape of the fiber in the cross section was evaluated by visual observation. A case where the shape of the fiber in the cross section does not change (not collapse) is determined to be “good”, and a case where the shape of the fiber has changed (collapse has occurred) is determined to be “bad”. It is preferable that the shape of the fiber does not change (not collapse) in the cross section.

### 7. Examples

### <Oil Agent>

In the following Examples, the following oil agents were used as the oil agent used for the fiber treatment agent.

Oil agent A: A hydrophilic oil agent manufactured by Takemoto Oil & Fat Co., Ltd. (containing an alkyl phosphate ester salt)

Oil agent B: A hydrophilic oil agent manufactured by Matsumoto Oil & Fat Pharmaceutical Co., Ltd. (containing an alkyl phosphate ester salt, having a higher polarity than the oil agent A)

Oil agent C: A silicone-containing oil agent manufactured by Takemoto Oil & Fat Co., Ltd. (containing a siloxane compound)

### Example 1

### (1) Production of Sheath-Core Type Composite Undrawn Fibers

As a core material, a raw material obtained by blending 1.5 mass % of an additive (“Clear Master PP-RM-NSA RMX50” manufactured by Dainichiseika Color & Chemicals Mfg. Co., Ltd.) in isotactic polypropylene “S119” manufactured by Prime Polymer Co., Ltd. was used. As a sheath material, a raw material obtained by blending 2.0 mass % of an additive (“Ultzex IR-5” manufactured by Prime Polymer Co., Ltd.) in high-density polyethylene “J300” manufactured by Asahi Kasei Chemicals Corporation was used. By using the core material and the sheath material, undrawn fibers having a sheath core structure were produced by melt spinning. At this time, a sheath-core type composite spinneret was used so that a sheath-core cross-sectional area ratio (sheath/core) was 50/50. The spinning conditions were set such that an extruder cylinder temperature was 270° C., a spinneret temperature was 275° C., and a spinning speed was 180 m/min. An aqueous solution prepared by mixing the oil agent A and the oil agent C at a weight ratio of 80:20 in a normal temperature state and adjusting an oil agent solution concentration to 4 wt % was applied to the obtained undrawn fibers using an oiling roller (fiber treatment agent adhering section 30). In this manner, undrawn fibers having a fineness of 0.8 dTex were obtained.

### (2) Production of Drawn Fibers

A drawing apparatus in which a steam heating drawing section (drawing treatment section 50) with normal pressure steam at 100° C. was placed between two rollers (an introducing roller (first roller 40) and a drawn fiber delivery roller (second roller 60)) was used so that a drawing step can be continuously carried out from the above-mentioned spinning step. A tow 11 of undrawn fibers was introduced by driving the first roller 40 at a speed of 180 m/min, and a tow 11 of drawn fibers was pulled out by increasing the speed of the second roller 60 from that of the first roller 40 at a predetermined magnification.

In the drawing step, when the speed of the delivery roller (second roller 60) was set to 781 m/min and the total drawing magnification was set to 4.34 times, drawn fibers could be obtained by industrially stably drawing fibers without causing fiber breakage and drawing breakage. The fineness of the obtained drawn fibers of Example 1 was 0.201 dTex.

### (3) Production of Staple Fibers

The tow of the drawn fibers obtained in the drawing step was immediately cut to a fiber length of 3.0 mm using a rotary cutter (cutter section 90, rotation speed: 50 m/min), whereby polyolefin-based staple fibers were obtained. A pressure at the time of cutting was 4.3 gf/dTex, a moisture content was 9.5 wt % with respect to the weight of the polyolefin-based staple fibers, and an oil agent adhesion amount was 1.2 wt % with respect to the weight of the polyolefin-based staple fibers.

### (4) Evaluation of Staple Fibers

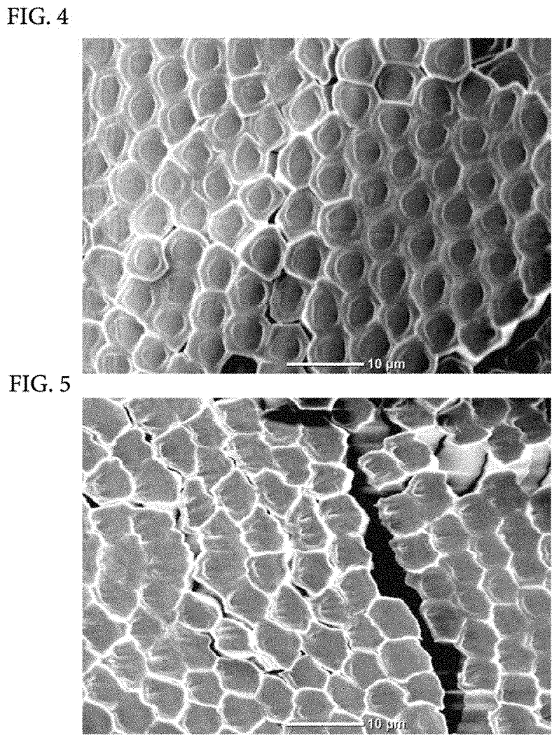

In the dry dispersion test (primary opening evaluation) of the obtained polyolefin-based staple fibers, the fibers were opened into a cotton-like state, and the passability evaluation was 30.2%. In the texture evaluation, a fiber lump or an uneven basis weight spot (shade) was not observed, and the texture was uniform. In the wet dispersion test (primary dispersion evaluation), the number of fiber lumps was 9, and after the pencil mixer was used in the secondary dispersion evaluation, the number of fiber lumps was 0, and the dispersibility was good. FIG. 4 is an SEM image showing cross sections of the staple fibers after the cutting treatment of Example 1. From FIG. 4, in Example 1, there was no shape deformation (shape collapse) of the fiber in the cross section.

### Example 2

### (1) Production of Sheath-Core Type Composite Undrawn Fibers

Production was performed in the same manner as in Example 1 except that the oil agent B was used in place of the oil agent A when undrawn fibers having a sheath core structure were produced.

### (2) Production of Drawn Fibers

Drawn fibers were produced in the same manner as in Example 1. In the drawing step, when the speed of the delivery roller (second roller 60) was set to 781 m/min and the total drawing magnification was set to 4.34 times, drawn fibers could be obtained by industrially stably drawing fibers without causing fiber breakage and drawing breakage. The fineness of the obtained drawn fibers of Example 2 was 0.200 dTex.

### (3) Production of Staple Fibers

A cutting treatment in which a pressure at the time of cutting the drawn fibers was 4.8 gf/dTex was performed in the same manner as in Example 1. A moisture content of the obtained polyolefin-based staple fibers was 9.1 wt %, and a fiber treatment agent adhesion amount was 1.0 wt % with respect to the weight of the polyolefin-based staple fibers.

### (4) Evaluation of Staple Fibers

In the dry dispersion test (primary opening evaluation) of the obtained polyolefin-based staple fibers, the fibers were opened into a cotton-like state, and the passability evaluation was 28.1%. In the texture evaluation, a fiber lump or an uneven basis weight spot (shade) was not observed, and the texture was uniform. In the wet dispersion test (primary dispersion evaluation), the number of fiber lumps was 9, and after the pencil mixer was used in the secondary dispersion evaluation, the number of fiber lumps was 0, and the dispersibility was good. From an SEM image, in Example 2, there was no shape deformation (shape collapse) of the fiber in the cross section.

### Example 3

### (1) Production of Sheath-Core Type Composite Undrawn Fibers

Sheath-core type composite undrawn fibers were produced in the same manner as in Example 1.

### (2) Production of Drawn Fibers

Drawn fibers were produced in the same manner as in Example 1. In the drawing step, when the speed of the delivery roller (second roller 60) was set to 781 m/min and the total drawing magnification was set to 4.34 times, drawn fibers could be obtained by industrially stably drawing fibers without causing fiber breakage and drawing breakage. The fineness of the obtained drawn fibers of Example 3 was 0.200 dTex.

### (3) Production of Staple Fibers

A moisture content was adjusted by leaving the tow 11 in which the drawn fibers were collected to stand at room temperature for 6 hours in the adjusting section 72 (drying treatment), and a cutting treatment in which a pressure at the time of cutting the drawn fibers was 4.8 gf/dTex was performed in the same manner as in Example 1. A moisture content of the obtained polyolefin-based staple fibers was 6.0 wt %, and a fiber treatment agent adhesion amount was 1.2 wt % with respect to the weight of the polyolefin-based staple fibers.

### (4) Evaluation of Staple Fibers

In the dry dispersion test (primary opening evaluation) of the obtained polyolefin-based staple fibers, the fibers were opened into a cotton-like state, and the passability evaluation was 29.8%. In the texture evaluation, a fiber lump or an uneven basis weight spot (shade) was not observed, and the texture was uniform. In the wet dispersion test (primary dispersion evaluation), the number of fiber lumps was 13, and after the pencil mixer was used in the secondary dispersion evaluation, the number of fiber lumps was 0, and the dispersibility was good. From an SEM image, in Example 3, there was no shape deformation (shape collapse) of the fiber in the cross section.

### Comparative Example 1

### (1) Production of Sheath-Core Type Composite Undrawn Fibers

Production was performed in the same manner as in Example 1 except that the oil agent B was used in place of the oil agent A when undrawn fibers having a sheath core structure were produced, and the oil agent B and the oil agent C were mixed at a weight ratio of 50:50.

### (2) Production of Drawn Fibers

Drawn fibers were produced in the same manner as in Example 1. In the drawing step, when the speed of the delivery roller (second roller 60) was set to 781 m/min and the total drawing magnification was set to 4.34 times, drawn fibers could be obtained by industrially stably drawing fibers without causing fiber breakage and drawing breakage. The fineness of the obtained drawn fibers of Comparative Example 1 was 0.200 dTex.

### (3) Production of Staple Fibers

A cutting treatment in which a pressure at the time of cutting the drawn fibers was 4.3 gf/dTex was performed in the same manner as in Example 1. A moisture content of the obtained polyolefin-based staple fibers was 7.1 wt %, and a fiber treatment agent adhesion amount was 1.0 wt % with respect to the weight of the polyolefin-based staple fibers.

### (4) Evaluation of Staple Fibers

In the dry dispersion test (primary opening evaluation) of the obtained polyolefin-based staple fibers, the fibers were opened into a cotton-like state, the passability evaluation was 95.1%, the fibers were aggregated into fiber lumps and did not pass through the sieve S2, and the texture evaluation could not be performed. In the wet dispersion test (primary dispersion evaluation), the number of fiber lumps was 0, and the dispersibility was good. Since a fiber lump was not observed in the primary dispersion evaluation, the secondary dispersion evaluation was not performed. From an SEM image, in Comparative Example 1, there was no shape deformation (shape collapse) of the fiber in the cross section.

### Comparative Example 2

### (1) Production of Sheath-Core Type Composite Undrawn Fibers

Sheath-core type composite undrawn fibers were produced in the same manner as in Example 1.

### (2) Production of Drawn Fibers

Drawn fibers were produced in the same manner as in Example 1. In the drawing step, when the speed of the delivery roller (second roller 60) was set to 781 m/min and the total drawing magnification was set to 4.34 times, drawn fibers could be obtained by industrially stably drawing fibers without causing fiber breakage and drawing breakage. The fineness of the obtained drawn fibers of Comparative Example 2 was 0.208 dTex.

### (3) Production of Staple Fibers

A moisture content was adjusted by subjecting the tow 11 in which the drawn fibers were collected to a drying treatment at 120 C with a drying furnace length of 2 m in the adjusting section 72, and a cutting treatment in which a pressure at the time of cutting the drawn fibers was 5.6 gf/dTex was performed in the same manner as in Example 1. A moisture content of the obtained polyolefin-based staple fibers was 0.4 wt %, and a fiber treatment agent adhesion amount was 2.9 wt % with respect to the weight of the polyolefin-based staple fibers.

### (4) Evaluation of Staple Fibers

In the dry dispersion test (primary opening evaluation) of the obtained polyolefin-based staple fibers, the fibers were opened into a cotton-like state, and the passability evaluation was 15.4%. In the texture evaluation, 8 fiber lumps or uneven basis weight spots (shades) were observed, and the texture was slightly bad. In the wet dispersion test (primary dispersion evaluation), the number of fiber lumps was 10, and after the pencil mixer was used in the secondary dispersion evaluation, the number of fiber lumps was 0, and the dispersibility was good. FIG. 5 is an SEM image showing cross sections of the staple fibers after the cutting treatment of Comparative Example 2. From FIG. 5, in Comparative Example 2, shape deformation (shape collapse) of the fiber in the cross section was observed.

### Comparative Example 3

### (1) Production of Sheath-Core Type Composite Undrawn Fibers

Production was performed in the same manner as in Example 1 except that only the oil agent A was used when undrawn fibers having a sheath core structure were produced.

### (2) Production of Drawn Fibers

Drawn fibers were produced in the same manner as in Example 1. In the drawing step, when the speed of the delivery roller (second roller 60) was set to 781 m/min and the total drawing magnification was set to 4.34 times, drawn fibers could be obtained by industrially stably drawing fibers without causing fiber breakage and drawing breakage. The fineness of the obtained drawn fibers of Comparative Example 3 was 0.201 dTex.

### (3) Production of Staple Fibers

A cutting treatment in which a pressure at the time of cutting the drawn fibers was 5.1 gf/dTex was performed in the same manner as in Example 1. A moisture content of the obtained polyolefin-based staple fibers was 4.2 wt %, and a fiber treatment agent adhesion amount was 1.2 wt % with respect to the weight of the polyolefin-based staple fibers.

### (4) Evaluation of Staple Fibers

In the dry dispersion test (primary opening evaluation) of the obtained polyolefin-based staple fibers, the fibers were opened into a cotton-like state, and the passability evaluation was 25.1%. In the texture evaluation, 10 or more fiber lumps or uneven basis weight spots (shades) were observed, and the texture was bad. In the wet dispersion test (primary dispersion evaluation), the number of fiber lumps was 50, but after the pencil mixer was used in the secondary dispersion evaluation, the number of fiber lumps was 0, and the fibers were in a state of being difficult to disperse. From an SEM image, in Comparative Example 1, shape deformation (shape collapse) of the fiber in the cross section was observed.

### Comparative Example 4

### (1) Production of Sheath-Core Type Composite Undrawn Fibers

Production was performed in the same manner as in Example 1 except that the oil agent B was used in place of the oil agent A when undrawn fibers having a sheath core structure were produced, and the oil agent B and the oil agent C were mixed at a weight ratio of 20:80.

### (2) Production of Drawn Fibers

Drawn fibers were produced in the same manner as in Example 1. In the drawing step, when the speed of the delivery roller (second roller 60) was set to 781 m/min and the total drawing magnification was set to 4.34 times, drawn fibers could be obtained by industrially stably drawing fibers without causing fiber breakage and drawing breakage. The fineness of the obtained drawn fibers of Comparative Example 4 was 0.202 dTex.

### (3) Production of Staple Fibers

A cutting treatment in which a pressure at the time of cutting the drawn fibers was 4.3 gf/dTex was performed in the same manner as in Example 1. A moisture content of the obtained polyolefin-based staple fibers was 14.0 wt %, and a fiber treatment agent adhesion amount was 1.1 wt % with respect to the weight of the polyolefin-based staple fibers.

### (4) Evaluation of Staple Fibers

The dry dispersion test (primary opening evaluation) of the obtained polyolefin-based staple fibers was performed, but the bundling property of the fibers was high, and the fibers were not opened into a cotton-like state. The passability evaluation and the texture evaluation could not be performed. In the wet dispersion test (primary dispersion evaluation), the number of fiber lumps was 0, and the dispersibility was good. Since a fiber lump was not observed in the primary dispersion evaluation, the secondary dispersion evaluation was not performed. From an SEM image, in Comparative Example 4, there was no shape deformation (shape collapse) of the fiber in the cross section.

### Comparative Example 5

### (1) Production of Sheath-Core Type Composite Undrawn Fibers

Production was performed in the same manner as in Example 1 except that an aqueous solution adjusted to 1.5 wt % of only the oil agent A was used when undrawn fibers having a sheath core structure were produced.

### (2) Production of Drawn Fibers

Drawn fibers were produced in the same manner as in Example 1. In the drawing step, when the speed of the delivery roller (second roller 60) was set to 781 m/min and the total drawing magnification was set to 4.34 times, drawn fibers could be obtained by industrially stably drawing fibers without causing fiber breakage and drawing breakage. The fineness of the obtained drawn fibers of Example 1 was 0.200 dTex.

### (3) Production of Staple Fibers

The tow 11 in which the drawn fibers obtained in the drawing step were collected was allowed to pass through a tank containing an aqueous solution of the oil agent A in a normal temperature state, in which the concentration of the oil agent solution was adjusted to 3 wt %, thereby applying the oil agent as a finishing oil agent to the drawn fibers, and cut to a fiber length of 3.0 mm using a rotary cutter (rotation speed: 45 m/min), whereby polyolefin-based staple fibers were obtained. A pressure at the time of cutting was 2.1 gf/dTex, a moisture content was 35 wt % with respect to the weight of the polyolefin-based staple fibers, and an oil agent adhesion amount was 2.0 wt % with respect to the weight of the polyolefin-based staple fibers. The application of the finishing oil agent is performed for the purpose of substantially increasing the moisture content in the fibers.

### (4) Evaluation of Staple Fibers

The dry dispersion test (primary opening evaluation) of the obtained polyolefin-based staple fibers was performed, but the bundling property of the fibers was high, and the fibers were not opened into a cotton-like state. The passability evaluation and the texture evaluation could not be performed. In the wet dispersion test (primary dispersion evaluation), the number of fiber lumps was 0, and the dispersibility was good. Since a fiber lump was not observed in the primary dispersion evaluation, the secondary dispersion evaluation was not performed. From an SEM image, in Comparative Example 5, there was no shape deformation (shape collapse) of the fiber in the cross section.

The above results are summarized in the following Table 1.

TABLE 1

| | | | | | | | Compar- | Compar- | Compar- | Compar- | Compar- |
|---|---|---|---|---|---|---|---|---|---|---|---|
| | | | | | | | ative | ative | ative | ative | ative |
| | | | | Exam- | Exam- | Exam- | Exam- | Exam- | Exam- | Exam- | Exam- |
| | | | | ple 1 | ple 2 | ple 3 | ple 1 | ple 2 | ple 3 | ple 4 | ple 5 |
| Configu- | Production | Cutting speed | m/min | 50 | 50 | 50 | 50 | 25 | 50 | 50 | 45 |
| ration | method | Pressure when | gf/dtex | 4.3 | 4.8 | 4.8 | 4.3 | 5.6 | 5.1 | 4.3 | 2.1 |
| | | cutting | | | | | | | | | |
| | Raw cotton | Resin | Core | PP | PP | PP | PP | PP | PP | PP | PP |
| | configu- | configuration | Sheath | PE | PE | PE | PE | PE | PE | PE | PE |
| | ration | Sheath/core | Sheath/ | 50/50 | 50/50 | 50/50 | 50/50 | 50/50 | 50/50 | 50/50 | 50/50 |
| | | ratio | core | | | | | | | | |
| | | Fineness | dtex | 0.201 | 0.200 | 0.200 | 0.200 | 0.208 | 0.201 | 0.202 | 0.200 |
| | | Initial moisture | wt % | 9.5 | 9.1 | 6.0 | 7.1 | 0.4 | 4.2 | 14.0 | 35 |
| | | content after | | | | | | | | | |
| | | cutting | | | | | | | | | |
| | Oil agent | Hydrophilic | Type | Oil | Oil | Oil | Oil | Oil | Oil | Oil | Oil |
| | configu- | oil agent | | agent A | agent B | agent A | agent B | agent A | agent A | agent B | agent A |
| | ration | Pure content | % | 80 | 80 | 80 | 50 | 80 | 100 | 20 | 100 |
| | | ratio | | | | | | | | | |
| | | Silicone-based | Type | Oil | Oil | Oil | Oil | Oil | — | Oil | — |
| | | oil agent | | agent C | agent C | agent C | agent C | agent C | | agent C | |
| | | Pure content | % | 20 | 20 | 20 | 50 | 20 | — | 80 | — |
| | | ratio | | | | | | | | | |
| | | Oil agent | % | 4 | 4 | 4 | 4 | 4 | 4 | 4 | Spinning: |
| | | solution | | | | | | | | | 1.5 |
| | | concentration | | | | | | | | | Finishing: |
| | | | | | | | | | | | 3.0 |
| | | Oil agent | % | 1.2 | 1.0 | 1.2 | 1.0 | 2.9 | 1.2 | 1.1 | 2.0 |
| | | adhesion ratio | | | | | | | | | |
| Evaluation | Dry | Primary | ◯ or X | ◯ | ◯ | ◯ | ◯ | ◯ | ◯ | X | X |
| | dispersion | opening | | | | | | | | | |
| | test | evaluation | | | | | | | | | |
| | | Passability | % | 30.2 | 28.1 | 29.8 | 95.1 | 15.4 | 25.1 | — | — |
| | | evaluation | | | | | | | | | |
| | | Texture | A to C, | A | A | A | — | B | C | — | — |
| | | evaluation | — | | | | | | | | |
| | Wet | Primary | Number | 9 | 9 | 13 | 0 | 10 | 50 or | 0 | 0 |
| | dispersion | dispersion | of lumps | | | | | | more | | |
| | test | evaluation | | | | | | | | | |
| | | Secondary | Number | 0 | 0 | 0 | 0 | 0 | 0 | 0 | 0 |
| | | dispersion | of lumps | | | | | | | | |
| | | evaluation | | | | | | | | | |
| | Cut cross | Fiber contour | Good | Good | Good | Good | Good | Bad | Bad | Good | Good |
| | section | in cross section | or bad | | | | | | | | |

As shown in the above Table 1, in the dry dispersion test, the staple fibers for air laid of Examples 1 to 3 obtained good results in any of the primary opening evaluation, the passability evaluation, and the texture evaluation, and it was confirmed that staple fibers having improved dispersibility were obtained. In Comparative Example 1, the fibers did not pass through the sieve S3 in the passability evaluation, and the texture evaluation could not be performed. In Comparative Example 2, B was given in the texture evaluation, and the texture was not good. In Comparative Example 3, C was given in the texture evaluation, and the texture was not good. In Comparative Examples 4 and 5, in the primary opening evaluation, the fibers were not opened. The pressure at the time of cutting was 5.0 gf/dTex or less in all the production methods of Examples 1 to 3.

The staple fibers for air laid of the present embodiment can be preferably used as staple fibers for forming a non-woven fabric by an air laid method.

The staple fibers for air laid of the present embodiment give a non-woven fabric having excellent chemical resistance, and can be preferably applied to staple fibers for forming a non-woven fabric used in various filter materials, battery separators, and the like.

The staple fibers for air laid of the present embodiment can also be applied as fibers for wet dispersion as can be seen from the fact that the secondary dispersion evaluation of wet dispersion is good.

### REFERENCE SIGN LIST

10A, 10B: Undrawn fiber
11: Tow
20: Spinning section
21: Conveying roller
30: Fiber treatment agent adhering section
31: Adhering roller
40: First roller
41: Roller
50: drawing treatment section
60: Second roller
61: Roller
70, 71: Conveying roller
72: Adjusting section
80: Adjusting roller
81: Roller
90: Cutter section
90A: Rotation shaft
91: Cylindrical section
91A: Cutting blade

1. Staple fibers for air laid, comprising stable fibers to which a fiber treatment agent containing a hydrophilic oil agent and a silicon-containing oil agent is adhered in an amount of 0.7 to 2 wt % of a weight of the staple fibers, wherein
a weight ratio of the hydrophilic oil agent and the silicon-containing oil agent contained in the fiber treatment agent (a weight of the hydrophilic oil agent/a weight of the silicon-containing oil agent) is within a range of 60/40 to 90/10, and
a moisture content is 2 to 13%.

2. The staple fibers for air laid according to claim 1, wherein the staple fibers have a fineness of 0.01 to 1.0 dTex.

3. The staple fibers for air laid according to claim 1, wherein the staple fibers have a fineness of 0.1 to 0.8 dTex.

4. The staple fibers for air laid according to claim 1, wherein the staple fibers are composite fibers having a sheath core structure in which a resin containing a crystalline propylene-based polymer as a main component is used as a core material, and a resin containing an olefinic polymer having a melting point lower than that of the core material as a main component is used as a sheath material.

5. The staple fibers for air laid according to claim 4, wherein a cross-sectional area ratio of the sheath material and the core material (sheath/core) is within a range of 5/95 to 80/20.

6. The staple fibers for air laid according to claim 1, wherein the moisture content is 5 to 10%.

7. The staple fibers for air laid according to claim 1, wherein the staple fibers have a fiber length of 1 to 10 mm.

8. The staple fibers for air laid according to claim 1, wherein the staple fibers have a fiber length of 2 to 5 mm.

9. A method for producing staple fibers for air laid, comprising:
obtaining undrawn fibers by melt spinning;
adhering a fiber treatment agent containing a hydrophilic oil agent and a silicon-containing oil agent to the undrawn fibers in an amount of 0.7 to 2 wt % of a weight of the fibers;
forming drawn fibers by subjecting the undrawn fibers to a drawing treatment; and
cutting the drawn fibers to a predetermined length, wherein
a weight ratio of the hydrophilic oil agent and the silicon-containing oil agent contained in the fiber treatment agent (a weight of the hydrophilic oil agent/a weight of the silicon-containing oil agent) is within a range of 60/40 to 90/10, and
the drawn fibers after the cutting the drawn fibers have a moisture content of 2 to 13%.

10. The method for producing staple fibers for air laid according to claim 9, wherein a pressure applied to the drawn fibers in the cutting the drawn fibers is 5.0 gf/dTex or less.
